(19) United States
(12) Patent Application Publication
(10) Pub. No.: US 2011/0125554 A1
(43) Pub. Date: May 26, 2011

(54) SYSTEM AND METHOD FOR IMPLEMENTING A DYNAMIC MARKET

(75) Inventor: Venson M. Shaw, Kirkland, WA (US)

(73) Assignee: AT&T MOBILITY II LLC, Atlanta, GA (US)

(21) Appl. No.: 12/623,660

(22) Filed: Nov. 23, 2009

(51) Int. Cl. G06Q 30/00; G06Q 10/00

(52) U.S. Cl. 705/7.41; 705/26.2

(57) ABSTRACT

A method and system for implementing a dynamic market system includes registering buyers and vendors of products and components associated with products. Buyers may send purchase requests to a dynamic vending engine, which may forward the purchase requests to vendors. Vendors may respond with sales offers. Buyers and vendors may organize into groups to obtain certain market advantages. When a purchase request for a product sub-system is received, the dynamic vending engine may automatically generate a number of purchase requests for product components included in the product sub-system.

### BACKGROUND

1. Field of the Disclosure

The present disclosure relates to vending systems and, more particularly, to dynamic vending in a dynamic market system.

2. Description of the Related Art

A typical product may be comprised of various sub-systems and components, which must be procured in order to manufacture and/or deliver the product. The overall procurement activity associated with a given product may involve numerous transactions among buyers and vendors.

### BRIEF DESCRIPTION OF THE DRAWINGS

FIG. 1 is a block diagram of selected elements of an example embodiment of a hierarchical product taxonomy;

FIG. 2 is a block diagram of selected elements of an embodiment of a dynamic market system;

FIG. 3 is a flow chart describing selected elements of an embodiment of a method for implementing a dynamic market system;

FIG. 4 is a block diagram of selected elements of an embodiment of a computing device; and

FIG. 5 is a flow chart describing selected elements of an embodiment of a method for implementing a dynamic market system.

### DESCRIPTION OF THE EXEMPLARY EMBODIMENTS

In one aspect, a disclosed method for dynamic vending includes receiving product information, the product information including descriptions of purchasable product components hierarchically associated with individual products. The method may further include storing the product information in a central database indexed at least by individual product, and receiving a purchase request from a buyer group to purchase a product component described in the product information, the request indicating a desired quantity of the product component. In response to transmitting the request to a vendor of the product component, the method may further include receiving a sales offer from the vendor for the product component, and providing the buyer group access to the sales offer.

In some embodiments, the method further includes registering a plurality of buyers for sending purchase requests. The operation of registering buyers may include obtaining buyer information and buyer acceptance of business terms for dynamic vending. The method may also include registering a plurality of vendors for sending sales offers. The operation of registering vendors may include obtaining vendor information and vendor acceptance of business terms for dynamic vending, while the vendor information may include descriptions of product components sold by individual ones of the plurality of vendors.

In certain embodiments, the method may still further include receiving a purchase request from a buyer for a product sub-system, and, based on the purchase request for the sub-system, generating a plurality of purchase requests for respective product components included in the product sub-system. The method may further include identifying buyers requesting to purchase the same product component and allowing the identified buyers to join a buyer group. The method may still further include enabling the buyer group to execute a sales transaction based on the sales offer.

In another aspect, a computer-readable memory media includes executable instructions for implementing a dynamic market system. The instructions may be executable to register a plurality of buyers for sending purchase requests, including obtaining buyer information and buyer acceptance of business terms for dynamic vending, register a plurality of vendors for sending sales offers, including obtaining vendor information and vendor acceptance of business terms for dynamic vending, and receive product information, including descriptions of purchasable product components hierarchically associated with individual products. The vendor information may include descriptions of product components sold by individual ones of the plurality of vendors. The memory media may further include instructions executable to receive a purchase request from a buyer group to purchase a product component described in the product information, the request indicating a desired quantity of the product component. Responsive to transmitting the request to a vendor group offering the product component, the instructions may be executable to receive a sales offer from the vendor group for the product component. Responsive to providing the buyer group access to the sales offer, the instructions may be executable to enable the buyer group to accept the sales offer. Responsive to the buyer group accepting the sales offer, the instructions may be executable to enable the buyer group to initiate a sales transaction based on the sales offer.

In certain embodiments, the memory media may further include instructions executable to identify registered buyers requesting to purchase the product component, enable the identified buyers to join the buyer group, identify registered vendors offering to sell the product component, and enable the identified vendors to join the vendor group. The memory media may further include instructions executable to receive a purchase request from a buyer for a product sub-system, and, based on the purchase request for the sub-system, generate a plurality of purchase requests for product components included in the product sub-system. The instructions may further be executable to obtain a respective plurality of sales offers for the plurality of purchase requests for product components included in the product sub-system. The instructions may still further be executable to combine the respective plurality of sales offers into an aggregate sub-system offer, and enable the buyer to access the aggregate sub-system offer. Responsive to the buyer indicating an acceptance of the aggregate sub-system offer, the instructions may be executable to send a respective plurality of purchase orders corresponding to the plurality of sales offers for product components included in the product sub-system.

In still another aspect, a disclosed service for implementing a dynamic market system includes registering a plurality of buyers for sending purchase requests, including obtaining buyer information and buyer acceptance of business terms for dynamic vending, and registering a plurality of vendors for sending sales offers, including obtaining vendor information and vendor acceptance of business terms for dynamic vending. The vendor information may include descriptions of product components sold by individual ones of the plurality of vendors. The service may further include receiving product information, including descriptions of purchasable product components hierarchically associated with individual products, and receiving a purchase request from a buyer group to purchase a product component described in the product information, the request indicating a desired quantity of the product component. Responsive to transmitting the request to a vendor group offering the product component, the service may also include receiving a sales offer from the vendor group for the product component. Responsive to providing the buyer group access to the sales offer, the service may then include enabling the buyer group to execute a sales transaction based on the sales offer.

In certain embodiments, the service may further include identifying registered buyers requesting to purchase the product component, and enabling the identified buyers to join the buyer group. The service may further include identifying registered vendors offering to sell the product component, enabling the identified vendors to join the vendor group. The service may still further include receiving a purchase request from a buyer for a product sub-system, and based on the purchase request for the sub-system, generating a plurality of purchase requests for respective product components included in the product sub-system.

In particular embodiments, the service may further include obtaining a respective plurality of sales offers for the plurality of purchase requests for product components included in the product sub-system, combining the respective plurality of sales offers into an aggregate sub-system offer, and enabling the buyer to access the aggregate sub-system offer. Responsive to the buyer indicating an acceptance of the aggregate sub-system offer, the service may also include sending a respective plurality of purchase orders corresponding to the plurality of sales offers for product components included in the product sub-system. The service may additionally include enabling registered buyers and registered vendors to access market information associated with the product components. The market information may include at least one of: geographical sales information, currency information, market volume information, price information, quantity information, discount information, bid-value information, ask-value information, buyer information, and vendor information. The service may yet further include enabling registered buyers and registered vendors to access a market analysis describing an anticipated market condition with respect to the product components.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

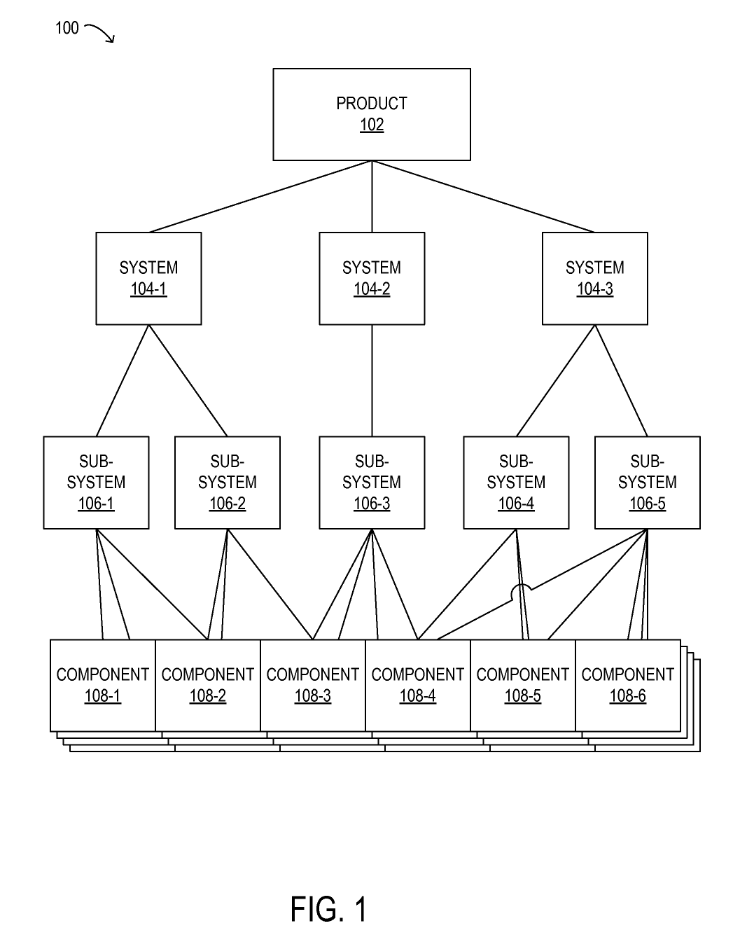

Referring now to FIG. 1, a block diagram of selected elements of hierarchical product taxonomy 100 is illustrated. As used herein, hierarchical product taxonomy 100 provides classification of groups of hierarchical elements associated with a generalized product. As such, hierarchical product taxonomy 100 represents a general example of how product 102 may be classified into systems 104, sub-systems 106, and components 108, and may describe how an actual product is classified into specific hierarchical elements.

In FIG. 1, product 102 may represent a physical product or a service, that is commercially provided to a buyer by a vendor (not shown in FIG. 1). Product 102 may further be associated with one or more manufacturers (not shown in FIG. 1) responsible for producing, preparing, or assembling product 102. Product 102 may still further be associated with a number of planners, designers, or developers (not shown in FIG. 1) who design, plan, or otherwise contribute to the creation of product 102. Thus, a number of entities may be involved in the design, development, manufacture, marketing, and sale of product 102.

As shown in FIG. 1, product 102, as defined by taxonomy 100, may be broken down into hierarchical elements, such as: systems 104, sub-systems 106, and components 108. It is noted that the hierarchical elements of product 102 may be physical elements, infrastructure elements, software elements, technical services, information repositories, or other types of generalized elements, in various embodiments. In various embodiments, hierarchical elements depicted in taxonomy 100 may themselves represent commercially available products and services. Furthermore, although product 102 is shown as a unitary element, product 102 (or another hierarchical element in taxonomy 100) may represent a multitude of instances, such as a network or a distributed implementation of a given product. For example, in one embodiment, product 102 may represent a certain type of telephone device. In another example implementation, product 102 may represent a telephone system comprising a multitude of telephone devices, along with additional deliverables, such as software and related services.

In FIG. 1, product 102 is shown with a hierarchical relationship to system 104-1, system 104-2, and system 104-3, representing an example implementation with three primary system elements. In some embodiments, systems 104 may represent certain functional or structural elements, which may be combined or assembled to form product 102. It is noted that systems 104 may represent system elements of product 102 that may be separately procured and integrated as a portion of product 102. It is further noted that, in particular embodiments, a combination of systems 104 may represent an incomplete portion of product 102, such that additional elements not depicted in taxonomy 100 may be included in product 102. Although not shown in FIG. 1, in certain embodiments, product 102 may share common systems 104, or may not include any systems 104.

In one embodiment of taxonomy 100, product 102 may be, for example, an electronic consumer device, such that system 104-1 may represent, for example, an external packaging, system 104-2 may represent, for example, a display system, while system 104-3 may represent, for example, an electronic system of product 102. In another embodiment of taxonomy 100, product 102 may represent, for example, a public network service in the form of a website provided by an Internet web server. In this example, system 104-1 may represent, for example, web server infrastructure, system 104-2 may represent, for example, a secondary network service provided by an external entity, while system 104-3 may represent, for example, a network database system for providing web pages on demand for the Internet website. It is noted that the examples of systems 104 described previously are representative examples for descriptive purposes, while actual implementations of systems 104 may encompass various numbers and types of system elements, representing a variety of products 102.

In exemplary taxonomy 100, sub-systems 106 may further represent sub-system elements, which may form certain portions of respective systems 104. Similar to systems 104, sub-systems 106 may represent certain functional or structural elements, which may be combined or assembled to complete a respective system 104. In various embodiments, sub-systems 106 may represent system elements of product 102 that may be separately procured and integrated as a portion of product 102. As shown in FIG. 1, system 104-1 may be comprised of sub-systems 106-1 and 106-2, system 104-2 may be comprised of sub-system 106-3, while system 104-3 may be comprised of sub-systems 106-4 and 106-5. Although not shown in FIG. 1, in certain embodiments, systems 104 may share common sub-systems 106, or may not include any sub-systems 106.

Also depicted in FIG. 1 are components 108, which represent the bottom-level hierarchical elements of taxonomy 100. It is noted that in different embodiments (not shown in FIG. 1), taxonomy 100 may be expanded to include addition hierarchical levels, such as sub-components, raw materials, commodities, etc., as desired. As shown in FIG. 1, components 108 may be variously combined and included with respective sub-systems 106. In various embodiments, components 108 may represent system elements of product 102 that may be separately procured and integrated as a portion of product 102. As shown in FIG. 1, sub-systems 106 may share common components 108. Although not shown in FIG. 1, in certain embodiments, sub-systems 106 may not include any components 108. In taxonomy 100, each lower level of the hierarchy includes a greater number of hierarchical elements. Accordingly, a large number of components 108 are depicted in FIG. 1, with exemplary components 108-1, 108-2, 108-3, 108-4, 108-5, and 108-6 explicitly shown with element numbers. Sub-systems 106 are accordingly shown in FIG. 1 with exemplary hierarchical relationships to various ones of components 108.

An illustrative feature of taxonomy 100, as depicted in FIG. 1, is that product 102 may be broken down into a hierarchy of constituent elements that themselves represent procurable items. During development or manufacture of product 102, each hierarchical element of product 102 may need to be procured. Accordingly, product 102 may be associated with a large amount of procurement effort involving a number of different vendors, quantities, offers, and purchase agreements, etc. Conventionally, the procurement effort may be static, in that each hierarchical element associated with product 102 is individually processed as a separate item during a procurement process. As will be described below, taxonomy 100 may be used as a basis for dynamic vending, by indexing hierarchical elements associated with a product to a procurement process for the product. In other words, hierarchical elements associated with product 102 may be automatically included in a procurement process once product 102 is selected.

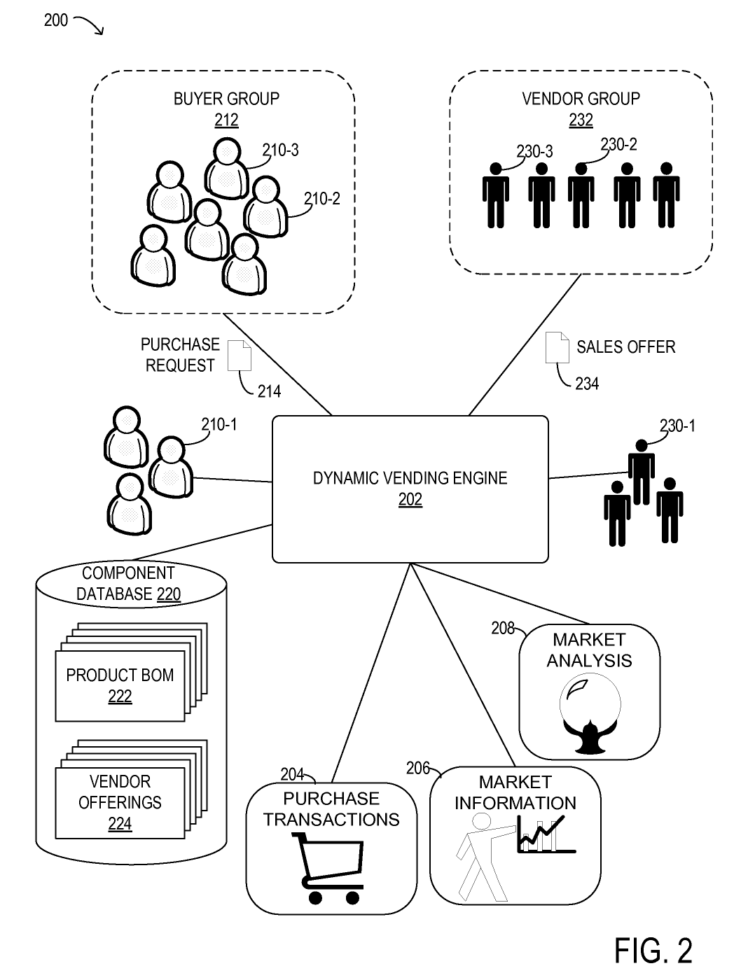

Turning now to FIG. 2, a block diagram of selected elements of an embodiment of dynamic market system 200 is illustrated. Dynamic market system 200 may be configured to implement dynamic vending of products and may accordingly be linked to a number of entities and resources. Dynamic market system 200, as shown, is based on dynamic vending engine 202, which may represent a networked platform configured to provide electronic services for dynamic vending of products.

In FIG. 2, dynamic vending engine 202 is shown coupled to component database 220. Component database 220 may include various repositories of information and data used by dynamic vending engine 202. As shown in FIG. 2, component database 220 includes product bills-of-materials (BOM) 222 and vendor offerings 224. Product BOM 222 may include a list of individual systems, subsystems, and components associated with a given product, as described above with respect to FIG. 1. Product BOM 222 may include information provided by buyers 210, among other sources. Dynamic vending engine 202 may be configured to link product BOM 222 with individual buyers, or to identify a group of buyers seeking to purchase the same component, subsystem, or system. Vendor offerings 224 may include information provided by vendors 230, among other sources, and may be indexed to individual ones of vendors 230. Vendor offerings 224 may thus include descriptions of individual components, subsystems, or systems offered for sale by specific vendors 230. Dynamic vending engine 202 may use vendor offerings 224 to identify specific vendors 230 for items requested for purchase by buyers 210.

In various embodiments, dynamic market system 200 may provide the ability to dynamically find sources of products and entities in need of products. Accordingly, dynamic market system 200 may enable dynamic negotiating, pricing, and settlements between vendors 230 and buyers 210. In an example configuration, vendors 230 and buyers 210 may be offered a subscription to participate in dynamic market system 200. In one embodiment, dynamic market system 200 is offered as a service (or an add-on service) by a communications network provider. In various embodiments, vendors 230 and buyers 210 may access dynamic market system 200 to access information pertaining to specific products, other vendors 230 and buyers 210, as well as current market conditions, fluctuations, and expected trends.

As shown in FIG. 2, buyer 210-1 and vendor 230-1 may individually access dynamic vending engine 202. Access to dynamic vending engine 202 may be provided via a wireless or a fixed network connection (not shown in FIG. 2). In various embodiments, buyers 210 and vendors 230 may access dynamic vending engine 202 using a mobile wireless device or using a stationary computing platform, such as a personal computer. Access to functionality provided by dynamic vending engine 202 may be via web pages, which may be accessible via a public network, such as the Internet.

In dynamic market system 200, buyers 210 and vendors 230 may collectivize their business activities by forming groups. A plurality of buyers 210 may form buyer group 212 in order to purchase certain items in larger quantities, and presumably at better terms, than may normally be possible by buyers 210 acting individually. For example, buyer 210-3 and buyer 210-2 may seek to purchase the same item and may join buyer group 212 for that purpose. Although a singular buyer group is shown in FIG. 2 for clarity, it will be understood that dynamic market system 200 may include a multitude of buyer groups, which may be formed based on a common demand for a variety of products. Similarly, vendors 230 may form vendor group 232 to obtain market advantages when participating in dynamic market system 200. For example, vendors 230 in vendor group 232 may be able to supply a larger quantity than would be possible by vendors 230 acting individually. Vendors 230 may gain access to larger or more regular market opportunities by participating in vendor groups. In certain embodiments, formation of vendor groups may contribute to stabilizing price fluctuations for certain products. For example, vendor 230-2 and vendor 230-3 may be able to supply certain quantities of the same product, as offered by vendor group 232. Other advantages of both buyer and vendor groups may be in marketing and/or advertising, where larger target audiences for specific products may be obtained.

In dynamic market system 200, buyer group 212 may thus send purchase request 214 to dynamic vending engine 202, representing a collective (or cumulative) demand for a common product among the members of buyer group 212. Dynamic vending engine 202 may then forward purchase request 214 to vendor group 232, which may represent a collective supply for the desired product. Vendor group 232 may then send sales offer 234 to dynamic vending engine 202, representing a collective offering by vendor group 232. Dynamic vending engine 202 may also forward purchase request 214 to other individual vendors that are not members of a vendor group, such as vendor 230-1, which may generate their own sales offers (not shown in FIG. 2). It is noted that dynamic vending engine 202 may be configured to accept individual purchase requests (not shown in FIG. 2) from buyers not members of a buyer group, such as buyer 210-1. Dynamic vending engine 202 may then provide buyers 210 and vendors 230 an opportunity to negotiate pricing and otherwise communicate on individual purchasing matters. In certain embodiments, dynamic vending engine 202 may enable buyers 210 and vendors 230 to communicate with each other, via text, email, audio, video, or other means.

Dynamic vending engine 202 may thus enable buyers 210 and vendors 230 to negotiate pricing, product amounts, and product sources, among other functionality, as described herein. Dynamic vending engine 202 may analyze market trends, conditions, and fluctuations, and provide such information to buyers 210 and vendors 230. As shown in FIG. 2, information provided by dynamic vending engine 202 may include market analysis 208, which may include predictions or estimates of future market activity, including projected trends. Dynamic vending engine 202 may further serve as a source of market information 206, such as actual market conditions, deal making, market volume, statistics, and other information. Dynamic vending engine 202 may still further be configured to execute purchase transactions 204, including tendering payment, managing delivery, and handling return merchandise authorizations, among other transactional functions.

It is further noted that dynamic market system 200 may represent a platform for providing services to a very large number of buyers 210 and vendors 230, who may be at geographically diverse locations. The services provided by dynamic vending engine 202 may accordingly be tailored to certain groups of participants, certain locations, or particular types of markets. For example, dynamic vending engine 202 may be configured to perform pricing in a number of different currencies, or to provide currency exchange information. Dynamic vending engine 202 may further be configured with preferences or rules that conform to certain market regulations or market functionality. For example, dynamic vending engine 202 may offer auctions, reverse-auctions, or may broadcast certain purchase requests or sales offers in a special manner. In one embodiment, dynamic vending engine 202 may make urgent purchase requests or purchase requests with a response deadline accessible to a number of vendors. In certain embodiments, dynamic vending engine 202 may generate a catalog of sales offers for certain items that are reduced in price or have been designated for liquidation.

In operation of dynamic market system 200, dynamic vending engine 202 may allow a number of buyers 210 and vendors 230 to register to use market services provided. Registration for market services provided by dynamic market system 200 may include opening an account, either as a buyer or a seller or both, whereby the account may track user activity and transactions performed using dynamic vending engine 202. Dynamic vending engine 202 may also proceed to obtain buyer information, vendor information, and product information. Dynamic vending engine 202 may store certain information in component database 220 as product BOM 222 and/or vendor offerings 224.

When dynamic vending engine 202 receives purchase request 214 from buyer 210 or buyer group 212 for a product, dynamic vending engine 202 may refer to product BOM 222 to dynamically link purchase request 214 to a number of individual purchase requests (not shown in FIG. 2) for individual items, such as systems, sub-systems, and components, associated with the product (see also FIG. 1). The purchase requests so generated may then be forwarded to vendors 230 or vendor group 232, who may respond with corresponding sales offer 234, or a number of individual sales offers (not shown in FIG. 2) for the respective individual items. Dynamic vending engine 202 may also facilitate communication between buyers 210 and vendors 230 regarding purchase requests and sales offers, for example, for further product inquiries, negotiations, delivery arrangements, payment arrangements, etc.

When buyer 210 and vendor 230 have agreed on a product purchase, dynamic vending engine 202 may be configured to facilitate a purchase via purchase transactions 204. In certain embodiments, certain functionality associated with purchase transactions 204 may be provided by an external entity, such as a credit card processor, or a freight shipment company. Furthermore, dynamic vending engine 202 may record purchases and other market activity, and provide such information to buyers 210, vendors 230, or other external entities, shown in FIG. 2 as market information 206 and market analysis 208, as described above. Market information 206 may include at least one of: geographical sales information, currency information, market volume information, price information, quantity information, discount information, bid-value information, ask-value information, buyer information, and vendor information. It is noted that market analysis 208 may also rely on information included in market information 206.

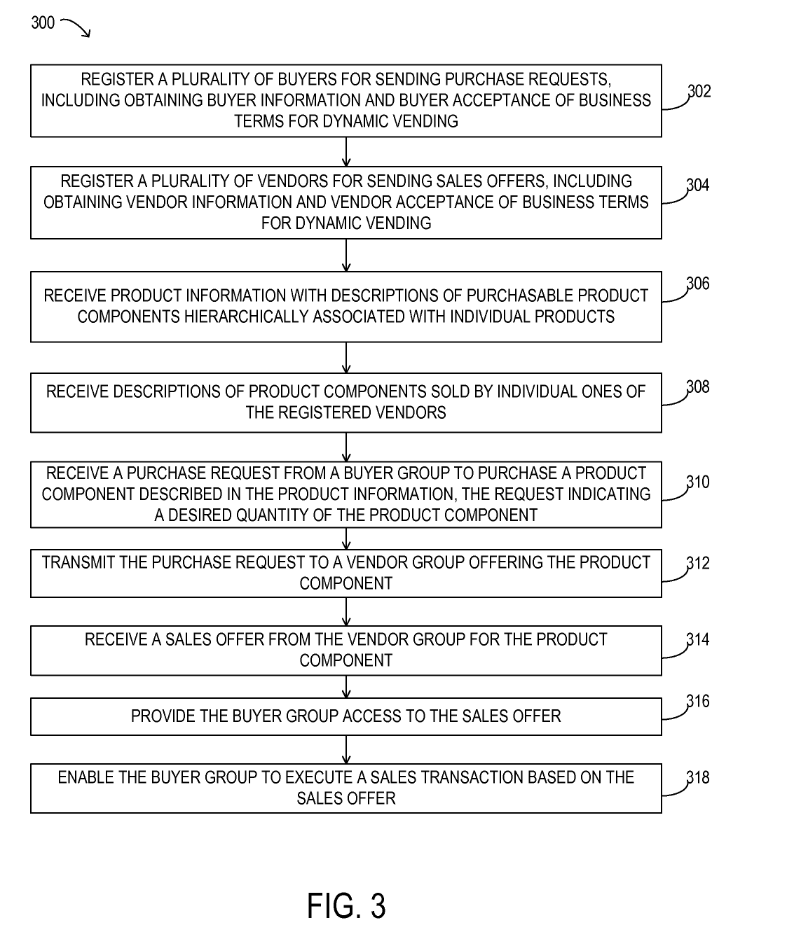

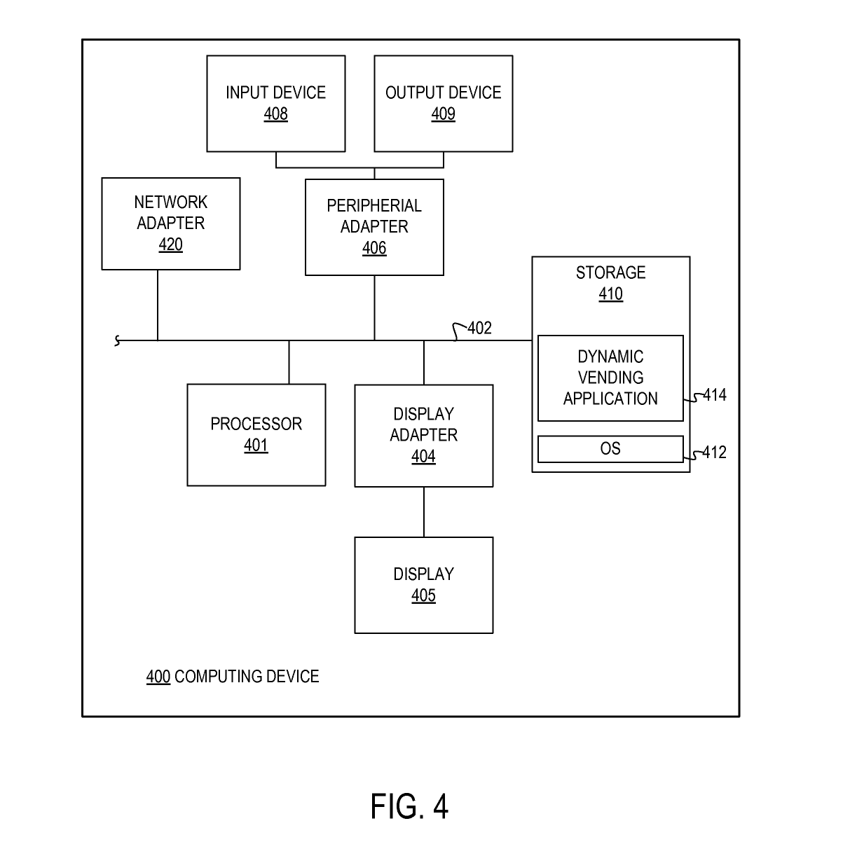

Turning now to FIG. 3, a flow chart describing selected elements of an embodiment of method 300 for implementing a dynamic market system is illustrated. It is noted that operations in method 300 may be omitted or rearranged in different embodiments, as desired. Method 300 may be executed, at least in part, by dynamic vending engine 202 (see FIG. 2). In some embodiments, dynamic vending application 414 (see FIG. 4) is configured to execute at least a portion of method 300.

A plurality of buyers may be registered for sending purchase requests, including obtaining buyer information and buyer acceptance of business terms for dynamic vending (operation 302). A plurality of vendors may be registered for sending sales offers, including obtaining vendor information and vendor acceptance of business terms for dynamic vending (operation 304). The business terms for dynamic vending may reflect conditions and contract provisions for participating as a buyer or a vendor or both in dynamic market system 200 (see FIG. 2). Registration may result in the creation of a user account, either as a buyer or a vendor or both, which may track all buyer activity when using dynamic market system 200 (see FIG. 2). Product information may be received, along with descriptions of purchasable product components hierarchically associated with individual products (operation 306). Descriptions of product components sold by individual ones of the registered vendors may be received (operations 308). The product information and descriptions of product components may be stored in a database accessible to dynamic vending engine 202, such as component database 220 (see FIG. 2). A purchase request, indicating a desired quantity of a product component, may be received from a buyer group to purchase the product component described in the product information (operation 310). In some cases, the purchase request may be received from individual buyers. The purchase request may be transmitted to a vendor group offering the product component (operation 312). In certain instances, the purchase request may be transmitted to individual vendors. A sales offer may be received from the vendor group for the product component (operation 314). The buyer group may be provided access to the sales offer (operation 316). The buyer group may be enabled to execute a sales transaction based on the sales offer (operation 318).

Referring now to FIG. 4, a block diagram illustrating selected elements of an embodiment of a computing device 400 is presented. In the embodiment depicted in FIG. 4, device 400 includes processor 401 coupled via shared bus 402 to storage media collectively identified as storage 410.

Device 400, as depicted in FIG. 4, further includes network adapter 420 that interfaces device 400 to a network (not shown in FIG. 4). In embodiments suitable for use in dynamic market systems, device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may comply with a display standard for the corresponding type of display. Standards for computer monitors include analog standards such as video graphics array (VGA), extended graphics array (XGA), etc., or digital standards such as digital video interface (DVI), high definition multimedia interface (HDMI), among others. A television display may comply with standards such as National Television System Committee (NTSC), Phase Alternating Line (PAL), or another suitable standard. Display 405 may include an output device 409, such as one or more integrated speakers to play audio content, or may include an input device 408, such as a microphone or video camera.

Storage 410 encompasses persistent and volatile media, fixed and removable media, and magnetic and semiconductor media. Storage 410 is operable to store instructions, data, or both. Storage 410 as shown includes sets or sequences of instructions, namely, an operating system 412, and dynamic vending application 414. Operating system 412 may be a UNIX or UNIX-like operating system, a Windows® family operating system, or another suitable operating system.

It is noted that in some embodiments, device 400 represents a computing device used by dynamic vending engine 202, shown in FIG. 2. In some cases, dynamic vending application 414 may be configured to provide functionality described in dynamic market system 200 (see FIG. 2).

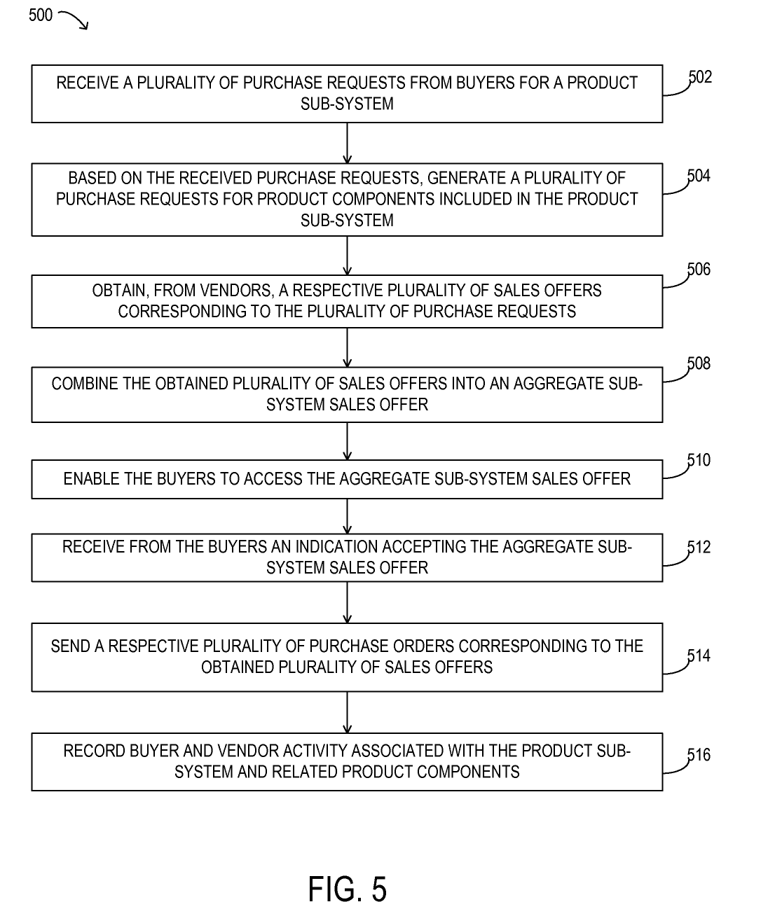

Turning now to FIG. 5, a flow chart describing selected elements of an embodiment of method 500 for implementing a dynamic market system is illustrated. It is noted that operations in method 500 may be omitted or rearranged in different embodiments, as desired. Method 500 may be executed, at least in part, by dynamic vending engine 202 (see FIG. 2). In some embodiments, dynamic vending application 414 (see FIG. 4) is configured to execute at least a portion of method 500.

A plurality of purchase requests for a product sub-system may be received from buyers (operation 502). Based on the received purchase requests, a plurality of purchase requests for product components included in the product sub-system may be generated (operation 504). A respective plurality of sales offers corresponding to the plurality of purchase requests may be obtained from vendors (operation 506). The obtained plurality of sales offers may be combined into an aggregate sub-system sales offer (operation 508). The buyers may be enabled to access the aggregate sub-system sales offer (operation 510). An indication accepting the aggregate sub-system sales offer may be received from the buyers (operation 512). A respective plurality of purchase orders corresponding to the obtained plurality of sales offers may be sent (operation 514). Sending the purchase orders may result in product components being delivered to buyers and payments being rendered to vendors. The activity by buyers and sellers associated with the product sub-system and related product components may be recorded (operation 516).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for dynamic vending, comprising:
receiving product information, the product information including descriptions of purchasable product components hierarchically associated with individual products;
storing the product information in a central database indexed at least by individual product;
receiving a purchase request from a buyer group to purchase a product component described in the product information, the request indicating a desired quantity of the product component;
in response to transmitting the request to a vendor of the product component, receiving a sales offer from the vendor for the product component; and
providing the buyer group access to the sales offer.

2. The method of claim 1, further comprising:
registering a plurality of buyers for sending purchase requests, said registering including obtaining buyer information and buyer acceptance of business terms for dynamic vending.

3. The method of claim 1, further comprising:
registering a plurality of vendors for sending sales offers, said registering including obtaining vendor information and vendor acceptance of business terms for dynamic vending, wherein the vendor information includes descriptions of product components sold by individual ones of the plurality of vendors.

4. The method of claim 1, further comprising:
receiving a purchase request from a buyer for a product sub-system; and
based on the purchase request for the sub-system, generating a plurality of purchase requests for respective product components included in the product sub-system.

5. The method of claim 1, further comprising:
identifying buyers requesting to purchase the same product component and allowing the identified buyers to join the buyer group.

6. The method of claim 1, further comprising:
enabling the buyer group to execute a sales transaction based on the sales offer.

7. Computer-readable memory media, including instructions for implementing a dynamic market system, said instructions executable to:
register a plurality of buyers for sending purchase requests, including obtaining buyer information and buyer acceptance of business terms for dynamic vending;
register a plurality of vendors for sending sales offers, including obtaining vendor information and vendor acceptance of business terms for dynamic vending, wherein the vendor information includes descriptions of product components sold by individual ones of the plurality of vendors;
receive product information, including descriptions of purchasable product components hierarchically associated with individual products;
receive a purchase request from a buyer group to purchase a product component described in the product information, the request indicating a desired quantity of the product component;
responsive to transmitting the request to a vendor group offering the product component, receive a sales offer from the vendor group for the product component;
responsive to providing the buyer group access to the sales offer, enable the buyer group to accept the sales offer; and
responsive to the buyer group accepting the sales offer, enable the buyer group to initiate a sales transaction based on the sales offer.

8. The memory media of claim 7, further comprising instructions executable to:
identify registered buyers requesting to purchase the product component;
enable the identified buyers to join the buyer group;
identify registered vendors offering to sell the product component; and
enable the identified vendors to join the vendor group.

9. The memory media of claim 7, further comprising instructions executable to:
receive a purchase request from a buyer for a product sub-system; and
based on the purchase request for the sub-system, generate a plurality of purchase requests for product components included in the product sub-system.

10. The memory media of claim 9, further comprising instructions executable to:
obtain a respective plurality of sales offers for the plurality of purchase requests for product components included in the product sub-system.

11. The memory media of claim 10, further comprising instructions executable to:
combine the respective plurality of sales offers into an aggregate sub-system offer; and
enable the buyer to access the aggregate sub-system offer.

12. The memory media of claim 11, further comprising instructions executable to:
responsive to the buyer indicating an acceptance of the aggregate sub-system offer, send a respective plurality of purchase orders corresponding to the plurality of sales offers for product components included in the product sub-system.

13. A service for implementing a dynamic market system, comprising:
registering a plurality of buyers for sending purchase requests, including obtaining buyer information and buyer acceptance of business terms for dynamic vending;
registering a plurality of vendors for sending sales offers, including obtaining vendor information and vendor acceptance of business terms for dynamic vending, wherein the vendor information includes descriptions of product components sold by individual ones of the plurality of vendors;
receiving product information, including descriptions of purchasable product components hierarchically associated with individual products;
receiving a purchase request from a buyer group to purchase a product component described in the product information, the request indicating a desired quantity of the product component;
responsive to transmitting the request to a vendor group offering the product component, receiving a sales offer from the vendor group for the product component; and
responsive to providing the buyer group access to the sales offer, enabling the buyer group to execute a sales transaction based on the sales offer.

14. The service of claim 13, further comprising:
identifying registered buyers requesting to purchase the product component; and
enabling the identified buyers to join the buyer group.

15. The service of claim 13, further comprising:
identifying registered vendors offering to sell the product component; and
enabling the identified vendors to join the vendor group.

16. The service of claim 13, further comprising:
receiving a purchase request from a buyer for a product sub-system; and
based on the purchase request for the sub-system, generating a plurality of purchase requests for respective product components included in the product sub-system.

17. The service of claim 16, further comprising:
obtaining a respective plurality of sales offers for the plurality of purchase requests for product components included in the product sub-system;
combining the respective plurality of sales offers into an aggregate sub-system offer; and
enabling the buyer to access the aggregate sub-system offer.

18. The service of claim 17, further comprising:
responsive to the buyer indicating an acceptance of the aggregate sub-system offer, sending a respective plurality of purchase orders corresponding to the plurality of sales offers for product components included in the product sub-system.

19. The service of claim 13, further comprising:
enabling registered buyers and registered vendors to access market information associated with the product components, wherein the market information includes at least one of: geographical sales information, currency information, market volume information, price information, quantity information, discount information, bid-value information, ask-value information, buyer information, and vendor information.

20. The service of claim 13, further comprising:
enabling registered buyers and registered vendors to access a market analysis describing an anticipated market condition with respect to the product components.
